(19) United States
(12) Patent Application Publication
(10) Pub. No.: US 2026/0259719 A1
(43) Pub. Date: Sep. 3, 2026

(54) CONTAINER IMAGE DEPLOYMENT

(71) Applicant: CVS Pharmacy, Inc., Woonsocket, RI (US)

(72) Inventors: Showeb Ahmad Siddiqui, Lincoln, RI (US); Jorge Falcon, Miami, FL (US)

(21) Appl. No.: 19/069,025

(22) Filed: Mar. 3, 2025

(51) Int. Cl. G06F 8/60; G06F 21/62

(52) U.S. Cl. CPC G06F 8/60; G06F 21/6227; G06F 21/6263

(57) ABSTRACT

A system, method, and computer-readable medium are described. An illustrative method may include generating container images according to one or more administrator preferences, restricting or controlling access to the container images such that, upon successful authentication, an administrator is allowed to define the one or more administrator preferences for the container images, and delivering the container images simultaneously to multiple devices across a communication network, where the container images, when received by the multiple devices, enable the multiple devices to deploy the container images such that each of the multiple devices behave according to the one or more administrator preferences.

### FIELD OF THE DISCLOSURE

The disclosure relates to systems and methods for intelligently and efficiently deploying new container images throughout a large computing infrastructure.

### BACKGROUND

The management of large and distributed computing systems, especially across large distances, presents many challenges. One of the primary challenges associated with managing such a computing system is the need to deploy updates and other system changes to various machines at various locations. Updates to some machines, but not others, may result in the entire system becoming inoperable or certain machines losing functionality. The loss of machines or machine functionality can negatively impact general operations as well as security associated with the various machines in the system.

### SUMMARY

It is with respect to the above-noted issues that examples of the present disclosure were contemplated. In particular, a continuous and efficient deployment solution for devices in a larger computing infrastructure are described herein. In some examples, use cases are described that support a variety of deployment types or execution types. Illustratively and without limitation, the deployment methods depicted and described herein can support the deployment of container images across a number of devices including servers, Point of Service (POS) registers, kiosks, handheld devices, Personal Digital Assistants (PDAs), tablets, phones, pharmacy registers, pharmacy servers, or the like. The container image(s), when deployed across the devices, may enable the devices to perform certain functions (e.g., sales functions, database lookup functions, etc.) and to interact with other devices in a desirable manner. By deploying container images according to the processes depicted and described herein, the various devices in a distributed computing infrastructure can be simultaneously and synchronously configured to interact with one another according to desired behaviors.

According to at least some examples of the present disclosure, a system is provided with a processor and memory including data stored therein that is executable by the processor, where the data stored in the memory includes: configuration engine instructions that to generate container images according to one or more administrator preferences; administrator portal instructions that provide authentication capabilities that restrict or control access to the configuration engine and that, upon successful authentication, enable an administrator to define the one or more administrator preferences; and package delivery engine instructions that cooperate with the configuration engine instructions to simultaneously deliver the container images generated by the configuration engine instructions to multiple devices across a communication network, wherein the container images, when received by the multiple devices, enable the multiple devices to deploy the container images such that each of the multiple devices behave according to the one or more administrator preferences.

According to another example, a non-transitory computer-readable medium is provided with processor-executable instructions that include: configuration engine instructions to generate container images according to one or more administrator preferences; administrator portal instructions to provide authentication capabilities that restrict or control access to the configuration engine and that, upon successful authentication, enable an administrator to define the one or more administrator preferences; and package delivery engine instructions that cooperate with the configuration engine instructions to simultaneously deliver the container images generated by the configuration engine instructions to multiple devices across a communication network, wherein the container images, when received by the multiple devices, enable the multiple devices to deploy the container images such that each of the multiple devices behave according to the one or more administrator preferences.

According to another example, a container deployment method is provided that includes: generating container images according to one or more administrator preferences; restricting or controlling access to the container images such that, upon successful authentication, an administrator is allowed to define the one or more administrator preferences for the container images; and delivering the container images simultaneously to multiple devices across a communication network, wherein the container images, when received by the multiple devices, enable the multiple devices to deploy the container images such that each of the multiple devices behave according to the one or more administrator preferences.

In one or more of the above examples, the multiple devices include at least one of an in-store device, a Personal Digital Assistant (PDA), a tablet, an in-store kiosk, a portable communication device, a pharmacy register, a pharmacy server, and a Point of Service (POS) device.

In one or more of the above examples, the container images are delivered to the multiple devices via one or more release bundles.

In one or more of the above examples, the package delivery engine instructions include data obfuscation capabilities that at least one of obfuscate, remove, redact, and hide information from an electronic communication prior to transmitting the electronic communication over the communication network.

In one or more of the above examples, the information includes personally identifiable information (PII).

In one or more of the above examples, the one or more administrator preferences define behaviors for the multiple devices to interact with one another.

In one or more of the above examples, the container images are delivered according to a release bundle that includes a collection of Key-Value pairs, where the Key in the Key-Value pairs comprises a container name and the Value in the Key-Value pairs comprises an image tag for the container to be deployed.

In one or more of the above examples, the one or more administrator preferences further define a time at which to deploy the release bundle.

Examples may include one of the following features, or any combination thereof.

All examples and features mentioned above can be combined in any technically possible way.

### BRIEF DESCRIPTION OF THE DRAWINGS

The present disclosure is described in conjunction with the appended figures, which are not necessarily drawn to scale:

FIG. 1 illustrates an example of a system in accordance with aspects of the present disclosure;

FIG. 2 illustrates details of a continuous deployment workflow in accordance with at least some examples of the present disclosure; and

FIGS. 3A – 3C illustrate details of a deployment method in accordance with at least some examples of the present disclosure.

### DETAILED DESCRIPTION

Before any examples of the disclosure are explained in detail, it is to be understood that the disclosure is not limited in its application to the details of construction and the arrangement of components set forth in the following description or illustrated in the following drawings. The disclosure is capable of other configurations and of being practiced or of being carried out in various ways. Also, it is to be understood that the phraseology and terminology used herein is for the purpose of description and should not be regarded as limiting.

While various examples will be described in connection with the deployment of container images across a plurality of devices in a large computing infrastructure, it should be appreciated that the examples can be utilized in smaller-scale deployments. For instance, a computing infrastructure having one, two, three, four, or many devices may benefit from utilizing the deployment processes depicted and described herein.

Aspects of the present disclosure support multiple deployment types and/or execution types. The deployment of container images may be achieved through the use of a release bundle. A release bundle may be utilized to initiate a deployment from a management server, to a host or a set of hosts (e.g., devices on which container images will be deployed). In some examples, a release bundle is a collection of Key-Value pairs, where the Key is the container name and the Value is the image tag for the container that needs to be deployed. All containers fields may be filled in for a deployment to be successful. However, if a container field is left blank during deployment, the management server may be configured to use previously defined tags, which are tags that have been previously set as a baseline for missing inputs (e.g., default tags).

In some examples, a user operating the management server (e.g., a system administrator) may be allowed to select an existing release bundle or create a new release bundle.

To create a release bundle, the system administrator may select one or more appropriate icons from a deployment job page, then further select an option to add a release bundle. When creating a new release bundle, the system administrator may provide a specific name for the bundle and the execution type, which may also be referred to as the use case or deployment type, and optionally a host to use as a baseline for the bundle. For instance, the host to which a container image is deployed may also be set as the baseline for other deployments in the same premises. The process may further including allowing the system administrator to create a bundle name and then select an execution type. The types of executions may include, without limitation, a POS Apps execution type (e.g., a deployment of container image(s) to selected servers supporting POS functionality), a POS Register execution type (e.g., a deployment of container image(s) to selected store registers), an RX Kiosk execution type (e.g., a deployment of container image(s) to selected in-store kiosks), an RX Connect execution type (e.g., a deployment of container image(s) to selected pharmacy registers), or a Store OS execution type (e.g., a deployment of container image(s) to selected store servers supporting other store functions, such as inventory management).

If the system administrator selects the use of a baseline deployment, then the selected host to be used as the baseline may have already been the recipient of a previous deployment. Selecting a host as a baseline may be achieved by first selecting an icon representing the host on a system administrator page, then selecting an option next to the icon allowing the selected host to be used as a baseline.

After a release bundle has been created and selected by the system administrator, the deployment can proceed with the system administrator filling in additional deployment inputs via a system administrator page. A deployment can be initiated after selecting one or more of the following: (1) Write and Pull preferences; (2) Selected hosts for deployment; (3) Selected release bundle; and (4) Time at which to deploy the bundle (e.g., immediate or at a selected time in the future). After the deployment has been defined and initiated, the management server responsible for executing the deployment may implement one or more feedback loops, where the initiated deployment processes from a network edge (e.g., a server residing at a retail store location) such that the network edge sends deployment status details back to the management server. With such feedback available to the management server, the system administrator can view specific deployment histories, status, and progress via their system administrator page. The deployments may be achieved using one or more continuous deployment workflows, as will be described in further detail herein.

The terms “user,” “administrator,” and “subject” may be used interchangeably herein to refer to one or more individuals operating a device.

Example aspects of the present disclosure are described with reference to the following figures.

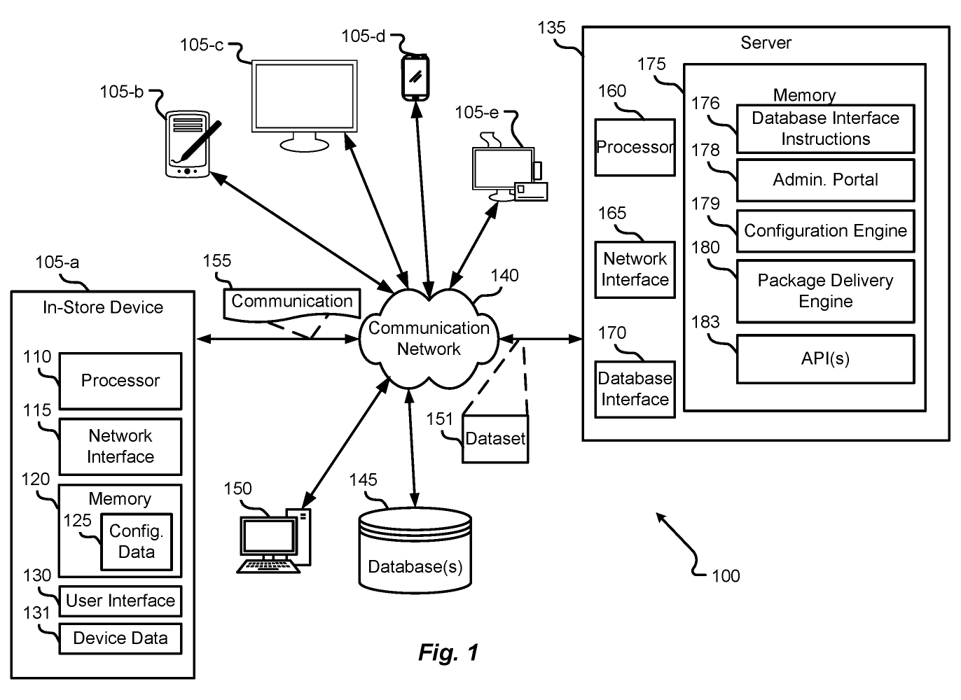

FIG. 1 illustrates an example of a system 100 in accordance with aspects of the present disclosure. The system 100, in some examples, may include one or more computing devices operating in cooperation with one another. The system 100 may also include a management server 135 that is capable of coordinating a deployment of image containers among other devices in the system 100. The system 100 may be, for example, an IT infrastructure as well as the management system to support the same.

The components of the system 100 may be utilized to facilitate one, some, or all of the methods described herein or portions thereof without departing from the scope of the present disclosure. Furthermore, the servers described herein may include example components or instruction sets, and aspects of the present disclosure are not limited thereto. In an example, a server may be provided with all of the instruction sets and data depicted and described in the server of FIG. 1. Alternatively, or additionally, different servers or multiple servers may be provided with different instruction sets than those depicted in FIG. 1.

The system 100 may include devices 105 (e.g., device 105-a through device 105-e), a management server 135, a communication network 140, and one or more databases 145. The communication network 140 may facilitate machine-to-machine communications between any of the device 105 (or multiple devices 105), the server 135, or one or more databases 145. The communication network 140 may include any type of known communication medium or collection of communication media and may use any type of protocols to transport messages between endpoints. The communication network 140 may include wired communications technologies, wireless communications technologies, or any combination thereof.

The Internet is an example of the communication network 140 that constitutes an Internet Protocol (IP) network consisting of multiple computers, computing networks, and other communication devices located in multiple locations, and components in the communication network 140 (e.g., computers, computing networks, communication devices) may be connected through one or more telephone systems and other means. Other examples of the communication network 140 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 140 may include of any combination of networks or network types. In some aspects, the communication network 140 may include any combination of communication mediums such as coaxial cable, copper cable/wire, fiber-optic cable, or antennas for communicating data (e.g., transmitting/receiving data). In some examples, the communication network 140 may be considered untrusted with respect to an entity that is administering the server 135 or a cloud computing environment representing the server 135.

A device 105 (e.g., an in-store device 105-a) may include a processor 110, a network interface 115, a computer memory 120, a user interface 130, and device data 131. In some examples, components of the device 105 (e.g., processor 110, network interface 115, computer memory 120, user interface 130) may communicate over a system bus (e.g., control busses, address busses, data busses) included in the device 105. In some cases, the device 105 may be referred to as a computing resource. The device 105 may establish one or more connections with the communication network 140 via the network interface 115. In some cases, the device 105 may transmit or receive packets to one or more other devices (e.g., another device 105, the server 135, the provider database 145, etc.) via the communication network 140.

Non-limiting examples of the device 105 may include, for example, personal computing devices or mobile computing devices (e.g., laptop computers, mobile phones, smart phones, smart devices, wearable devices, tablets, etc.). In some examples, the device 105 may be operable by or carried by a human user. In some aspects, the device 105 may perform one or more operations autonomously or in combination with an input by the user.

The device 105 may support one or more operations or procedures associated with facilitating a user experience in a brick-and-mortar retail location. In some cases, the system 100 may include any number of communication devices 105, and each of the communication devices 105 may be associated with a respective entity.

The device 105 may render or output any combination of notifications, messages, reports, menus, etc. based on data communications transmitted or received by the device 105 over the communication network 140. For example, the device 105 may receive one or electronic communications 155 (e.g., from the server 135) via the communication network 140. As will be described herein, the server 135 may be configured to send electronic communications 155 to multiple devices 105 to support a deployment of container images across all devices 105 substantially simultaneously. Additionally, or alternatively, the system 100 may support communications of any electronic communications 155 between any device of the system 100, and the electronic communications 155 may include any combination of transmitted or received data as described herein.

In some aspects, the device 105 may render a presentation (e.g., visually, audibly, using haptic feedback, etc.) of the electronic communication 155 via the user interface 130. The user interface 130 may include, for example, a display, an audio output device (e.g., a speaker, a headphone connector), or any combination thereof. In some aspects, the device 105 may render a presentation using one or more applications (e.g., a POS application, an inventory application, etc.) stored on the memory 120. In an example, the application executed by the device 105 may be executed according to configuration data 125. As will be described in further detail herein, the container images delivered to the device 105 by the management server 135 may cause the configuration data 125 to be stored in memory 120 and/or to update existing configuration data already stored in memory. The configuration data 125 stored in memory 120 may be utilized by the device 105 to support operations thereof, including behaviors of application(s) on the device 105, functionality of hardware on the device 105 (e.g., the processor 110, network interface 115, the user interface 130, etc.).

Devices 105 of the system 100 may include any suitable type of device utilized in a retail store, pharmacy, or other brick-and-mortar location. Non-limiting examples of suitable device 105 types include an in-store device 105-a, a Personal Digital Assistant (PDA) or tablet 105-b, an in-store kiosk 105-c, a portable communication device 105-d (e.g., a cellular phone, smart phone, etc.), and/or a POS device 105-e. As noted above, the electronic communication 155 may include a container image. The devices 105 may also be configured to share datasets 151 with the management server 135. The datasets 151 may provide a current state of the configuration data 125 on a device 105 or other information that enables the management server 135 to manage the device 105 and/or generate a new container image for transmission to the device 105.

Operations of the server 135 may be facilitated through an administrator terminal 150. A system administrator using the administrator terminal 150 may be configured to interact with the management server 135, generate release bundles for transmission to devices 105, update release bundles, and/or perform other management tasks associated with administering the devices 105 in the system 100.

The database(s) 145 may include member electronic records (also referred to herein as a data records) stored therein. In some aspects, the electronic records may be accessible to a device 105 (e.g., operated by healthcare provider personnel, insurance provider personnel, a customer, a pharmacist, etc.) and/or the server 135. In some aspects, a device 105 and/or the server 135 may receive and/or access the electronic records from the database 145 based on a set of permissions. In an example, the device 105 and/or server 135 may access a dataset 151 from the database 145.

In some other aspects, the electronic records stored in the database(s) 145 may include device data 131 and/or configuration data 125 obtained from a device 105 (e.g., device 105-a). Thus, the database(s) 145 may correspond to IT management databases, retail databases, or the like. Alternatively or additionally, the database(s) 145 may be configured to store information regarding customers of a retail location. In such a configuration, the database(s) 145 may correspond to a Customer Relationship Management (CRM) database, an inventory management database, a customer history database, a prescription database, or the like.

The server 135 may include a processor 160, a network interface 165, a database interface 170, and a memory 175. In some examples, components of the server 135 (e.g., processor 160, a network interface 165, a database interface 170, and a memory 175) may communicate via a system bus (e.g., any combination of control busses, address busses, and data busses) included in the server 135. Aspects of the processor 160, network interface 165, database interface 170, and memory 175 may support example functions of the server 135 as described herein. For example, the server 135 may transmit packets to (or receive packets from) one or more other devices (e.g., one or more devices 105, another server 135, the database 145, etc.) via the communication network 140. In some aspects, via the network interface 165, the server 135 may transmit database queries to one or more databases 145 of the system 100, receive responses associated with the database queries, or access data associated with the database queries.

In some aspects, via the network interface 165, the management server 135 may transmit one or more electronic communications 155 described herein to one or more devices 105 of the system 100. The network interface 165 may include, for example, any combination of network interface cards (NICs), network ports, associated drivers, or the like. Communications between components (e.g., processor 160, network interface 165, database interface 170, and memory 175) of the server 135 and other devices (e.g., one or more devices 105, the database(s) 145, another server 135) connected to the communication network 140 may, for example, flow through the network interface 165.

The processors described herein (e.g., processor 110 of the device 105, processor 160 of the server 135) may correspond to one or many computer processing devices. For example, the processors may include a silicon chip, such as a Field Programmable Gate Array (FPGA), an Application-Specific Integrated Circuit (ASIC), any other type of Integrated Circuit (IC) chip, a collection of IC chips, or the like. In some aspects, the processors may include a microprocessor, a Central Processing Unit (CPU), a Graphics Processing Unit (GPU), or plurality of microprocessors configured to execute the instructions sets stored in a corresponding memory (e.g., memory 120 of the device 105, memory 175 of the server 135). For example, upon executing the instruction sets stored in memory 175, the processor 110 may enable or perform one or more functions of the device 105. In another example, upon executing the instruction sets stored in memory 175, the processor 160 may enable or perform one or more functions of the server 135.

The processors described herein (e.g., processor 110 of the device 105, processor 160 of the server 135) may utilize data stored in a corresponding memory (e.g., memory 120 of the device 105, memory 175 of the server 135) as a neural network. The neural network may include a machine learning architecture. In some aspects, the neural network may be or include one or more classifiers. In some other aspects, the neural network may be or include any machine learning network such as, for example, a deep learning network, a convolutional neural network, or the like. Some elements stored in memory 120 may be described as or referred to as instructions or instruction sets, and some functions of the device 105 may be implemented using machine learning techniques. In another example, some elements stored in memory 175 may be described as or referred to as instructions or instruction sets, and some functions of the server 135 may be implemented using machine learning techniques.

The memory described herein (e.g., memory 120, memory 175) may include any type of computer memory device or collection of computer memory devices. For example, a memory (e.g., memory 120, memory 175) may include a Random Access Memory (RAM), a Read Only a Memory (ROM), a flash memory, an Electronically-Erasable Programmable ROM (EEPROM), Dynamic RAM (DRAM), or any combination thereof.

The memory described herein (e.g., memory 120, memory 175) may be configured to store instruction sets and other data structures (e.g., depicted herein) in addition to temporarily storing data for a respective processor (e.g., processor 110, processor 160) to execute various types of routines or functions. For example, the memory 175 may be configured to store program instructions (instruction sets) that are executable by the processor 160 and provide functionality of any of the engines described herein. Any of the engines described herein may include a single or multiple engines.

The illustrative data or instruction sets that may be stored in memory 175 may include, for example, database interface instructions 176, an administrator portal 178, a configuration engine 179, and a package delivery engine 180. The memory 175 may also store one or more Application Programming Interfaces (APIs) 183 to support interactions between various components of the system 100. In some examples, the package delivery engine 180 may include data obfuscation capabilities via which the reporting engine 180 may obfuscate, remove, redact, or otherwise hide personally identifiable information (PII) from an electronic communication 155 prior to transmitting the electronic communication 155 to another device (e.g., device 105). The package delivery engine 180 may also be responsible for cooperating with the configuration engine 179 and for delivering one or more container images generated by the configuration engine 179.

In some examples, the database interface instructions 176, when executed by the processor 160, may enable the server 135 to send data to and receive data from the database 145. For example, the database interface instructions 176, when executed by the processor 160, may enable the server 135 to generate database queries, provide one or more interfaces for system administrators to define database queries, transmit database queries to one or more databases 145, receive responses to database queries, access data associated with the database queries, and format responses received from the databases for processing by other components of the server 135.

The server 135 may use the administrator portal 178 to support interactions with the administrator terminal 150. In some examples, the administrator portal 178 may also include authentication capabilities that restrict or control user access to the configuration engine 179 and/or package delivery engine 180 and other features of the server 135 unless and until a user has successfully authenticated themselves with the server 135.

The configuration engine 179 and package delivery engine 180, as noted above, may cooperate with one another to generate container images and deploy container images to one or multiple devices 105 within the system 100. For instance, the configuration engine 179 may be configured to generate container images according to preferences or selections made by an administrator at the administrator terminal 150 and then the package delivery engine 180 may be responsible for sending such container images and other executable instructions to the devices 105 across the communication network 140.

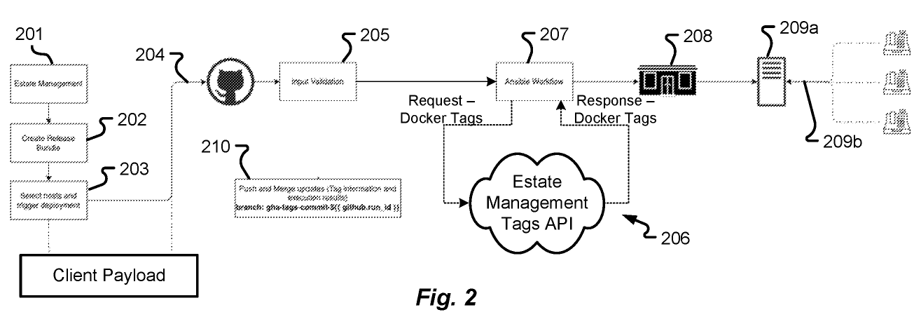

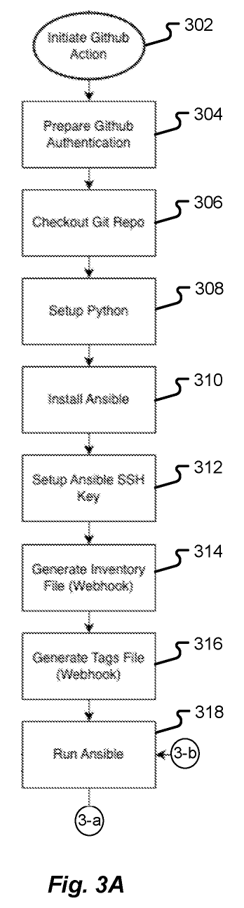

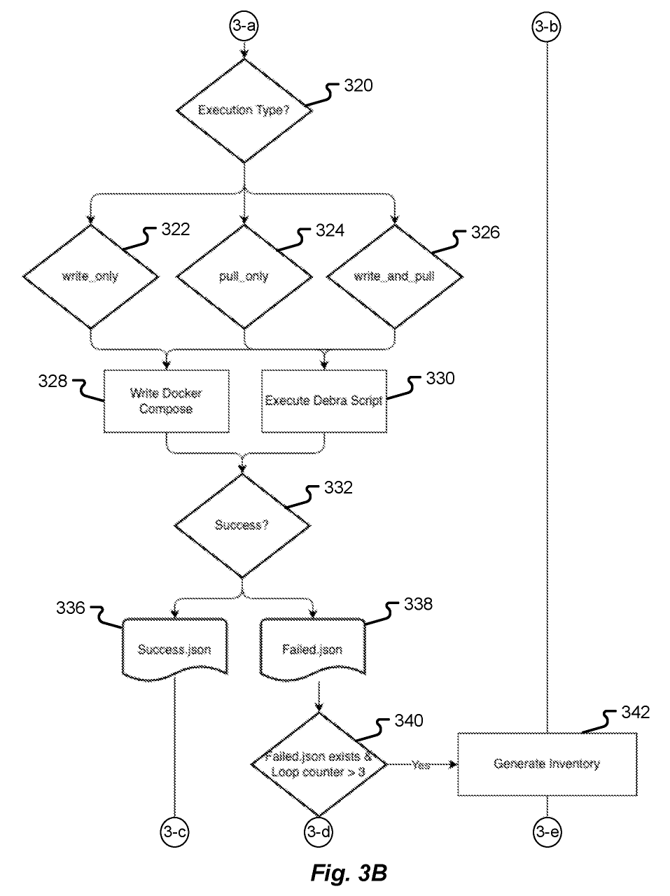

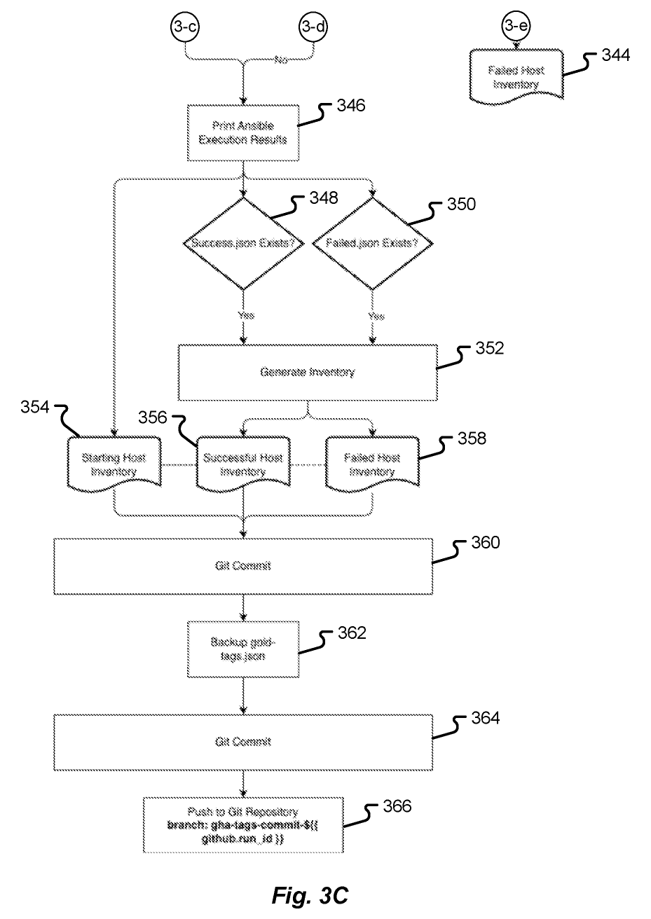

Example illustrative aspects of the system 100 are described with reference to FIGS. 2 and 3.

FIG. 2 illustrates an example workflow designed to reuse one or more workflows via a webhook and with a limited number of administrator inputs (e.g., less than 10 inputs required). The implementation of the workflow illustrated in FIG. 2 can help efficiently deploy container images among a plurality of devices 105. The workflow includes a first step 201 in which a system administrator, via the administrator terminal 150, accesses the estate management server 135.

The workflow then includes a second step 202 where the administrator creates a release bundle using the configuration engine 179. The release bundle may be used to generate a client payload for delivery to selected devices 105. The workflow may include a further step where the system administrator selects one or more hosts (e.g., devices 105) to receive the client payload (e.g., the container image) at step 203. The system administrator may also select the appropriate release bundle to use for the deployment and the trigger conditions (e.g., either immediate or after a predetermined amount of time).

In some examples, the client payload may include one or more inputs and one or more tags. The inputs may include, for example, environment definitions, docker-compose actions, inventory names, host names, execution types, and/or whether or not to utilize forced deployment. The tags may include, for example, service tags, device types, integration services, proxy configurations, and/or alert monitoring services.

The workflow then includes the server 135 utilizing the package delivery engine 180 to post client payloads to a webhook, thereby triggering a deployment pipeline in step 204. The deployment pipeline may begin validating inputs to ensure necessary fields are passed in and are not null in step 205.

The workflow may proceed to step 207, which may include a deployment of docker containers in which tags are retrieved from server 135 in step 206, per defined host, and used. In some examples, the workflow utilized in step 207 may correspond to a configurable workflow that sequences a plurality of individual job templates (e.g., workflow templates). The workflow templates may or may not share inventory, playbooks, or permissions. The workflow utilized in step 207 may, however have administrative and/or execution permissions that enable the workflow to accomplish the task of tracking the full set of jobs that are part of a release process as a single unit. The workflow of step 207 allow you to configure a sequence of disparate job templates (or workflow templates) that may or may not share inventory, playbooks, or permissions. However, workflows have ‘admin’ and ‘execute’ permissions, similar to job templates. A workflow accomplishes the task of tracking the full set of jobs that were part of the release process as a single unit.

Job or workflow templates may be linked together using a graph-like structure called nodes. A template can be part of different workflows or used multiple times in the same workflow of step 207. A copy of the graph structure may be saved to a workflow job when launching the workflow of step 207.

Via a secure network protocol (e.g., Secure Shell (SSH)), the workflow of step 207 may connect to store servers for the hosts passed in the client_payload in step 208. Via the secured connection, the workflow of step 207 may utilize a docker compose template for the use-case, write the docker compose template to a specific directory for the use-case, and initiate one or more scripts to download the docker images and initiate a docker compose up process in step 209a. In the event of a register deployment, a docker compose template is still written to the server of the store in which the register is located, but the scripts used in step 209a will not bring up any containers on the store server. Instead, the store server will be prepared to allow registers, via an automated process, to pull the docker compose files, pull associated containers from a local register, and issue a docker compose up process in step 209b.

The workflow may then include one or more final steps of taking the result file(s) and pushing them to a branch created specifically for the pipeline in step 210. In this push and manage step, a pull request may be created and then merged into a main request.

Referring now to FIGS. 3A, 3B, and 3C, additional details of a deployment method will be described in accordance with at least some examples of the present disclosure. The method may, in some examples, utilize one or more keys (e.g., SSH keys) to be populated as a secret. Examples of such keys include a store-specific key (e.g., STORE_SSH_KEY) and a production-specific key (e.g., STORE_SSH_KEY_PRODUCTION). The method may also utilize one or more secrets, which may be populated amongst locations in which deployments of containers are desired ahead of a pipeline execution.

The method begins when a Github action is initiated (step 302). The Github action may be prepared for authentication as part of initiating the action or in response to initiating the action (step 304).

The method may continue by checking out a Git Repo (step 306) and then setting up a Phtyhon (step 308) for the action. Thereafter, a predetermined workflow (e.g., an Ansible Workflow) may be installed (step 310) and set up with one or more security keys (step 312).

The method may further include generating an inventory file (e.g., a webhook) (step 314). The webhook may include one or more of a release bundle name, a job ID, an environment, an inventory file name, a definition of write only/pull only/write and pull, an execution type (e.g., posapps), one or more hosts, and/or one or more tags.

The method may then include generating one or more tags files (step 316). The tags may then be retrieved from server 135 using the inventory file (e.g., the webhook). The method may then include running the predetermined workflow (e.g, the Ansible Workflow) (step 318). In some examples, a playbooks associated with the predetermined workflow is executed.

The method may then proceed by evaluating the execution type (step 320). During evaluation of the execution type, it may be determined if the execution type is a write only execution type (step 322), a pull only execution type (step 324), or a write and pull execution type (326). Depending on the execution type identified in step 320, one of the steps 322, 324, or 326 may be performed. In execution of a write only execution type, the docker-compose file may be written to one or more identified servers (step 328). In execution of a pull only execution type, no docker-compose file is written and one or more scripts may be called (step 330). In execution of a write and pull execution type, a docker-compose file is written (step 328) and one or more scripts may be called (step 330).

The execution of steps 328 and/or 330 may be analyzed to determine if the execution was successful (step 332). Results of the execution may be written to the json payload if a success.json is populated with zero failures (step 336). On the other hand, if a failed.json is populated with failed hosts (step 338), then a counter is initiated (step 340) and a new inventory file is created based on the failed.json file (step 342). In this step, the script may return to step 318 up to a predetermined number of times (e.g., at least three times) before exiting the loop between steps 340, 342, and 318. If the execution is still failed after the predetermined number of times, then a failed host inventory message is generated and sent to a system administrator (step 344).

In some examples, execution results may be printed (step 346) and inventory may be generated (step 352) regardless of whether a success.json exists (step 348) or a failed.json exists (step 350). The inventory may be generated for one or more of: starting host inventories (step 354), successful host inventories (step 356), and/or failed host inventories (step 358).

After appropriate inventories have been generated, a Git Commit is generated (step 360 and/or 364) and pushed to an appropriate repository (step 366). In some examples, the successful inventories may be copied to an inventory backup location (step 362) prior to being committed to an appropriate repository (step 366).

It should be appreciated that the above-noted method may be executed for one or more of a POS application deployment, a POS register application deployment, a pharmacy kiosk deployment, and/or a pharmacy application deployment.

While the examples illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed examples, configuration, and aspects.

A number of variations and modifications of the disclosure can be used. It would be possible to provide for some features of the disclosure without providing others.

In yet another example, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another examples, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another example, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the examples with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various examples, configurations, and aspects, includes components, methods, processes, systems and/or apparatus substantially as depicted and described herein, including various examples, subcombinations, and subsets thereof. Those of skill in the art will understand how to make and use the systems and methods disclosed herein after understanding the present disclosure. The present disclosure, in various examples, configurations, and aspects, includes providing devices and processes in the absence of items not depicted and/or described herein or in various examples, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more examples, configurations, or aspects for the purpose of streamlining the disclosure. The features of the examples, configurations, or aspects of the disclosure may be combined in alternate examples, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed example, configuration, or aspect. Thus, the following claims are hereby incorporated into this Detailed Description, with each claim standing on its own as a separate preferred example of the disclosure.

Moreover, though the description of the disclosure has included description of one or more examples, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative examples, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an example that is entirely hardware, an example that is entirely software (including firmware, resident software, micro-code, etc.) or an example combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A system, comprising:
a processor; and
memory comprising data stored therein that is executable by the processor, wherein the data stored in the memory comprises:
configuration engine instructions that generate container images according to one or more administrator preferences;
administrator portal instructions that provide authentication capabilities that restrict or control access to the configuration engine and that, upon successful authentication, enable an administrator to define the one or more administrator preferences; and
package delivery engine instructions that cooperate with the configuration engine instructions to simultaneously deliver the container images generated by the configuration engine instructions to multiple devices across a communication network, wherein the container images, when received by the multiple devices, enable the multiple devices to deploy the container images such that each of the multiple devices behave according to the one or more administrator preferences.

2. The system of claim 1, wherein the multiple devices include at least one of an in-store device, a Personal Digital Assistant (PDA), a tablet, an in-store kiosk, a portable communication device, a pharmacy register, a pharmacy server, and a Point of Service (POS) device.

3. The system of claim 1, wherein the container images are delivered to the multiple devices via one or more release bundles.

4. The system of claim 1, wherein the package delivery engine instructions include data obfuscation capabilities that at least one of obfuscate, remove, redact, and hide information from an electronic communication prior to transmitting the electronic communication over the communication network.

5. The system of claim 4, wherein the information comprises personally identifiable information (PII).

6. The system of claim 1, wherein the one or more administrator preferences define behaviors for the multiple devices to interact with one another.

7. The system of claim 1, wherein the container images are delivered according to a release bundle that includes a collection of Key-Value pairs, wherein a Key in the Key-Value pairs comprises a container name and a Value in the Key-Value pairs comprises an image tag for the container to be deployed.

8. The system of claim 7, wherein the one or more administrator preferences further define a time at which to deploy the release bundle.

9. A non-transitory computer-readable medium comprising processor-executable instructions that include:
configuration engine instructions to generate container images according to one or more administrator preferences;
administrator portal instructions to provide authentication capabilities that restrict or control access to the configuration engine and that, upon successful authentication, enable an administrator to define the one or more administrator preferences; and
package delivery engine instructions that cooperate with the configuration engine instructions to simultaneously deliver the container images generated by the configuration engine instructions to multiple devices across a communication network, wherein the container images, when received by the multiple devices, enable the multiple devices to deploy the container images such that each of the multiple devices behave according to the one or more administrator preferences.

10. The non-transitory computer-readable medium of claim 9, wherein the multiple devices include at least one of an in-store device, a Personal Digital Assistant (PDA), a tablet, an in-store kiosk, a portable communication device, a pharmacy register, a pharmacy server, and a Point of Service (POS) device.

11. The non-transitory computer-readable medium of claim 9, wherein the container images are delivered to the multiple devices via one or more release bundles.

12. The non-transitory computer-readable medium of claim 9, wherein the package delivery engine instructions include data obfuscation capabilities that at least one of obfuscate, remove, redact, and hide information from an electronic communication prior to transmitting the electronic communication over the communication network.

13. The non-transitory computer-readable medium of claim 12, wherein the information comprises personally identifiable information (PII).

14. The non-transitory computer-readable medium of claim 9, wherein the one or more administrator preferences define behaviors for the multiple devices to interact with one another.

15. The non-transitory computer-readable medium of claim 9, wherein the container images are delivered according to a release bundle that includes a collection of Key-Value pairs, wherein a Key in the Key-Value pairs comprises a container name and a Value in the Key-Value pairs comprises an image tag for the container to be deployed.

16. The non-transitory computer-readable medium of claim 15, wherein the one or more administrator preferences further define a time at which to deploy the release bundle.

17. A container deployment method, comprising:
generating container images according to one or more administrator preferences;
restricting or controlling access to the container images such that, upon successful authentication, an administrator is allowed to define the one or more administrator preferences for the container images; and
delivering the container images simultaneously to multiple devices across a communication network, wherein the container images, when received by the multiple devices, enable the multiple devices to deploy the container images such that each of the multiple devices behave according to the one or more administrator preferences.

18. The method of claim 17, wherein the multiple devices include at least one of an in-store device, a Personal Digital Assistant (PDA), a tablet, an in-store kiosk, a portable communication device, a pharmacy register, a pharmacy server, and a Point of Service (POS) device.

19. The method of claim 17, wherein the one or more administrator preferences define behaviors for the multiple devices to interact with one another.

20. The method of claim 17, wherein the container images are delivered according to a release bundle that includes a collection of Key-Value pairs, wherein a Key in the Key-Value pairs comprises a container name and a Value in the Key-Value pairs comprises an image tag for the container to be deployed.
